(19) United States
(12) Patent Application Publication
(10) Pub. No.: US 2024/0281919 A1
(43) Pub. Date: Aug. 22, 2024

(54) EFFECT PROCESSING METHOD AND DEVICE

(71) Applicant: Lemon Inc., Grand Cayman (KY)

(72) Inventors: Jiali Pan, Beijing (CN); Haipeng Liu, Beijing (CN); Boyuan Hu, Beijing (CN); Anda Li, Los Angeles, CA (US)

(21) Appl. No.: 18/567,695

(22) PCT Filed: Sep. 22, 2022
(86) PCT No.: PCT/SG2022/050685

§ 371 Date: Dec. 6, 2023

(30) Foreign Application Priority Data
Oct. 18, 2021 (CN) 202111209146.3

(51) Int. Cl. G06T 1/20; G06T 11/00

(52) U.S. Cl. CPC G06T 1/20; G06T 11/001; G06T 2210/56

(57) ABSTRACT

Embodiments of the present disclosure provide an effect processing method and apparatus. The method comprises: acquiring effect resource data comprising a self-defined effect logic, the effect logic being used for specifying at least one effect processor and at least two associated effect processing units included in each effect processor; generating the effect processor and the effect processing units according to the effect logic, the effect processing units being used for processing the particles through a shader of a GPU; according to an association relationship between the effect processing units, sequentially invoking the effect processing units to process particles corresponding to the effect processor, to obtain an effect picture, wherein the particles are display objects of geometry.

### CROSS REFERENCE TO RELATED APPLICATIONS

The present application claims a priority right to the Chinese patent application No. 202111209146.3 entitled “Effect Processing Method and Device” filed with the Chinese Patent Office on Oct. 18, 2021, the entire disclosure of which is hereby incorporated by reference in its entirety.

### FIELD

Embodiments of the present disclosure relate to the field of computer processing technologies, and particularly to an effect processing method and apparatus.

### BACKGROUND

A effect picture refers to a picture with a special visual effect added to an image, video, text, etc. A typical effect picture may be made up of a large number of particles, each particle being a unit of an arbitrary shape. Each particle is independent and moving and changing constantly. The movement is regular or irregular, and the change may be a change in color, transparency, size, etc. For example, a fireworks effect may be simulated by a large number of particles. An upward movement of a large number of particles may simulate the rising of fireworks, each particle disappears after rising to a certain height and meanwhile more particles are displayed at the disappearing position of the particle to simulate an explosion effect of fireworks.

It can be seen that the process of generating the above-mentioned effect picture may be a process of generating particles, updating particles and rendering particles. The more diversified the number of particles, the colors of particles, the size of particles, the relationship between particles, etc. included in an effect picture, the better the richness of the effect picture. Therefore, how to improve the richness of the effect picture becomes an urgent problem to be solved.

### SUMMARY

The present disclosure provides an effect processing method and device, which may improve the diversity of an effect picture.

In a first aspect, embodiments of the present disclosure provide an effect processing method comprising:
acquiring effect resource data comprising a self-defined effect logic, the effect logic being used for specifying at least one effect processor and at least two associated effect processing units included in each effect processor;
generating the effect processor and the effect processing units according to the effect logic, each effect processor corresponding to a set of particles, and the effect processing units being used for processing the particles through a shader of a Graphic Processing Unit GPU;
according to an association relationship between the effect processing units included in the effect processor, sequentially invoking the effect processing units to process particles corresponding to the effect processor, to obtain an effect picture, wherein each of the effect processing units is used for performing one type of the following type of processing: generating the particles, updating attributes of the particles, and rendering the particles according to the attributes of the particles, and wherein the particles are display objects of geometry.

In a second aspect, embodiments of the present disclosure provide an effect processing apparatus, comprising:
an effect resource acquiring module for acquiring effect resource data comprising a self-defined effect logic, the effect logic being used for specifying at least one effect processor and at least two associated effect processing units included in each effect processor;
an effect processor generating module for generating the effect processor and the effect processing units according to the effect logic, each effect processor corresponding to a set of particles, and the effect processing units being used for processing the particles through a shader of a Graphic Processing Unit GPU;
an effect processing module for according to an association relationship between the effect processing units included in the effect processor, sequentially invoke the effect processing units to process particles corresponding to the effect processor, to obtain an effect picture, wherein each effect processing unit is used for performing one type of the following type of processing: generating the particles, updating attributes of the particles, and rendering the particles according to the attributes of the particles, and wherein the particles are display objects of geometry.

In a third aspect, embodiments of the present disclosure provide an electronic device comprising: at least one processor and a memory;
the memory stores computer-executable instructions;
the at least one processor executes the computer-executable instructions stored in the memory, to cause the electronic device to implement the method according to the first aspect.

In a fourth aspect, embodiments of the present disclosure provide a computer-readable storage medium having stored therein computer-executable instructions which, when executed by a processor, cause a computing device to implement the method according to the first aspect.

In a fifth aspect, embodiments of the present disclosure provide a computer program for implementing the method according to the first aspect.

In a sixth aspect, embodiments of the present disclosure provide a computer program product comprising a computer program for implementing the method according to the first aspect.

Embodiments of the present disclosure provide an effect processing method and device. The method comprises: acquiring effect resource data comprising a self-defined effect logic, the effect logic being used for specifying at least one effect processor and at least two associated effect processing units included in each effect processor; generating the effect processor and the effect processing units according to the effect logic, each effect processor corresponding to a set of particles, and the effect processing units being used for processing the particles through a shader of a GPU; according to an association relationship between the effect processing units included in the effect processor, sequentially invoking the effect processing units to process particles corresponding to the effect processor, to obtain an effect picture, wherein each of the effect processing units is used for performing one type of the following type of processing: generating the particles, updating attributes of the particles, and rendering the particles according to the attributes of the particles. In the embodiments of the present disclosure, a plurality of effect processing units may be assembled dynamically to achieve the diversity of an association relationship between effect processing units. Since each effect processing unit is used to update the particles, the diversity the association relationship between the effect processing units may diversify the update relationship of the particles. Thus, rich effect pictures may be simulated by a plurality of particles whose update relationship is diversified.

### BRIEF DESCRIPTION OF THE DRAWINGS

Figures to be used in the depictions of embodiments will be introduced briefly in order to illustrate technical solutions of embodiments of the present disclosure more clearly. It is obvious that the figures in the following depictions are merely some embodiments described in the present disclosure, and those skilled in the art man further obtain other figures according to these figures without making any inventive efforts.

FIG. 1 is a schematic view showing a specific effect picture of simulating an explosion effect of fireworks by particles;

FIG. 2 illustrates a flow chart of steps of an effect processing method provided by an embodiment of the present disclosure;

FIG. 3 is a schematic diagram of an effect processor and effect processing units provided by an embodiment of the present disclosure;

FIG. 4 is a schematic diagram of a process for generating an effect picture according to an embodiment of the present disclosure;

FIG. 5 is a block diagram of a specific processing apparatus according to an embodiment of the present disclosure;

FIG. 6 and FIG. 7 are block diagrams of two types of electronic devices provided by embodiments of the present disclosure.

### DETAILED DESCRIPTION OF EMBODIMENTS

To make objectives, technical solutions and advantages of embodiments of the present disclosure more apparent, the technical solutions in embodiments in the disclosure will be described below clearly and completely with reference to figures in the embodiments of the disclosure. Obviously, the described embodiments are only partial embodiments in the disclosure rather than all embodiments. All other embodiments obtained by those skilled in the art without making inventive efforts based on the embodiments in the disclosure should fall within the scope of protection of the present disclosure.

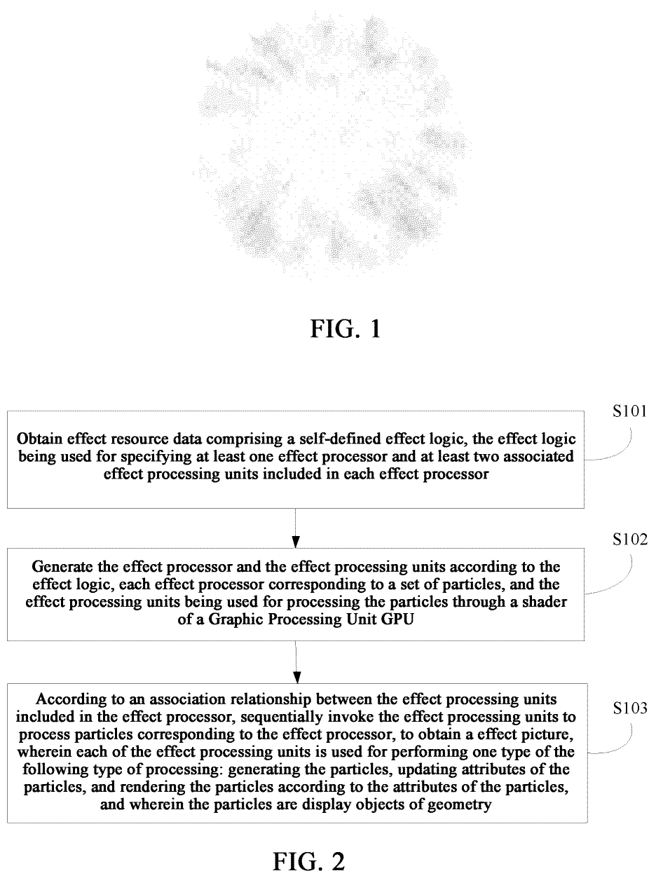

Embodiments of the present disclosure may be applied to a process of simulating an effect picture by particles. FIG. 1 is a schematic view showing a specific effect picture of simulating an explosion effect of fireworks by particles, wherein one particle may be constituted by one or more adjacent pixel points. Certainly, the effects picture that may be simulated by particles may include, but is not limited to: a cloud and fog effect, a volcanic explosion effect and a flame effect.

The above-mentioned effect picture may be implemented and performed by an electronic device provided with a processor that may perform a lot of computing and a screen that may display particles. The processor may be a CPU (central processing unit) or a GPU (graphics processing unit).

Since the effect picture is formed by the movement of a large number of particles, the processor is required to have a powerful computing capability. As compared with the CPU, the GPU has a better parallel computing capability, so the computing performance of particles may be improved effectively by using the GPU to simulate the effect picture.

In the prior art, when the effect picture is simulated by the GPU, attributes of the particles are updated in a fixed manner, thereby causing a poor diversity of the effect picture.

To address the above-described problem, in embodiments of the present disclosure, a plurality of effect processing units may be assembled dynamically to achieve the diversity of an association relationship between effect processing units. Since each effect processing unit is used to update the particles, the diversity the association relationship between the effect processing units may diversify the update relationship of the particles. Thus, the diversified effect pictures may be simulated by a plurality of particles whose update relationship is diversified.

The technical solutions of the embodiments of the present disclosure and how the technical solutions of the present disclosure solve the above-mentioned technical problems will be described in detail in the following specific embodiments. The following specific embodiments may be combined with one another, and the same or similar concepts or processes might not be repeated in some embodiments. Embodiments of the present disclosure will now be described with reference to the accompanying drawings.

FIG. 2 illustrates a flow chart of steps of an effect processing method provided by an embodiment of the present disclosure. The method may be applied to an electronic device. Referring to FIG. 2, the method comprises:

S101: acquiring effect resource data comprising a self-defined effect logic, the effect logic being used for specifying at least one effect processor and at least two associated effect processing units included in each effect processor;

The effect resource data is used for describing information needed by the generated effect picture, and the effect pictures generated by different effect resource data are different. As shown in FIG. 4, effect resource data may include, but not limited to: effect logic, externally-input data, internal attributes, internal textures, initialized particle attributes, and shader information corresponding to each effect processing unit. The effect resource data may be obtained from a pre-generated effect map.

The effect processing unit is the GPU described above.

The above-mentioned externally-input data is sent by the CPU to the GPU for indicating a user-input instruction. For example, the externally-input data indicates that the user makes a click operation at a certain position.

The internal attributes may be, for example, time.

The internal textures may be textures used when the particles are rendered.

The initialized particle attributes are initialized attributes of the particles, and are used to initialize the attributes of the particles when generating the particles.

The shader information of the effect processing unit may be an identifier of a shader and used to specify a shader for each effect processing unit, i.e., specify processing logic corresponding to the effect processing unit.

S102: generating the effect processor and the effect processing units according to the effect logic, each effect processor corresponding to a set of particles, and the effect processing units being used for processing the particles through a shader of a GPU.

Each effect processor is used for processing a set of particles which have the same attribute update logic. The set of particles comprises a predetermined number of particles.

The shader of the GPU is classified into a computational shader and a vertex/pixel shader according to functions. The computational shader is used for computation and the vertex/pixel shader is used for rendering. Thus, effect processing units having different processing logic may employ different shaders. For example, when the effect processing units are used to generate particles, or to update attributes of the particles, the computational shader may be adopted. When the effect processing units are used to render particles, a vertex/pixel shader may be adopted.

The above-described computational shader may be used to build a computing pipeline and bind pre-created GPU resources to the computing pipeline such that the computing pipeline uses the GPU resources for computation.

The vertex/pixel shader described above is used to bind the attributes of the particles updated by the computational shader to a rendering pipeline to output the particles through the rendering pipeline to the screen.

It needs to be appreciated that a process of generating the effect processing units is a process of determining the corresponding shader for the effect processing units. In addition, some initialization may also be performed on the effect processing units so as to set relevant information about the effect processing units, for example, a thread corresponding to the effect processing units and GPU resources used by the effect processing units.

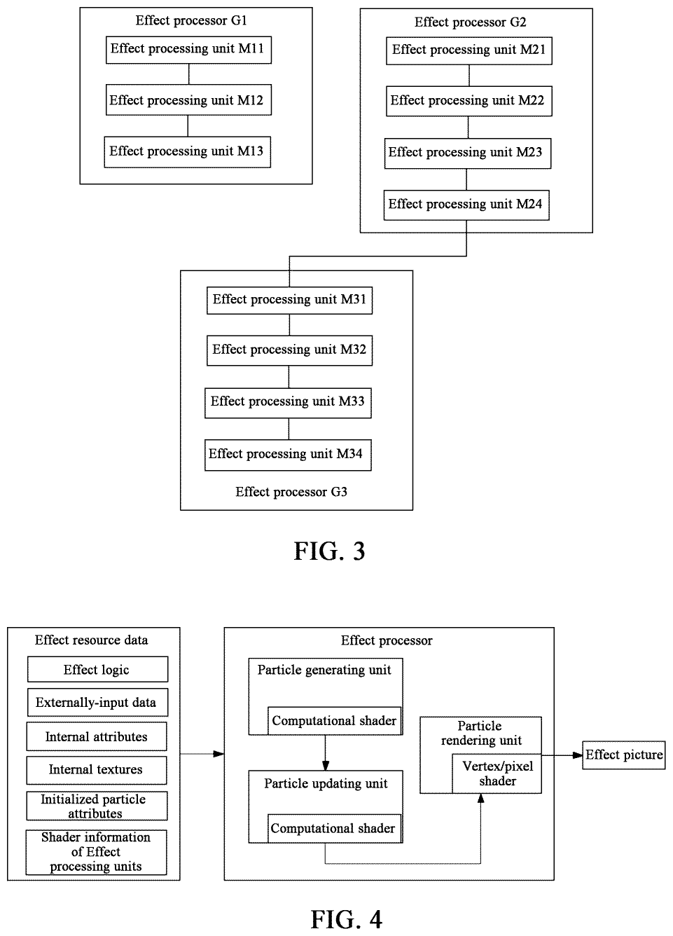

FIG. 3 is a schematic diagram of an effect processor and effect processing units provided by an embodiment of the present disclosure. Referring to FIG. 3, effect processors G1 and G2 are not associated with each other, and G2 and G3 are associated with each other. That is, G1 processes a set of particles independently; after G2 processes a set of particles, G3 needs to process another set of particles according to the particles processed by G2.

It can also be seen from FIG. 3 that each effect processor comprises a plurality of effect processing units.

G1 includes three effect processing units M11, M12 and M13, wherein M11 may be used to generate a set of particles L1, M12 may be used to update attributes of L1, and M13 may be used to render the updated L1. That is, M11 and M12 are computational shaders and M13 is a vertex/pixel shader.

For G2, it includes four effect processing units M21, M22, M23 and M24. M21 may be used to generate a set of particles L2, M22 may be used to update the attributes of L2, and M23 and M24 may be used to render the updated L1. That is, M21, M22 are computational shaders and M23, M24 are vertex/pixel shaders. The vertex/pixel shaders employed by M23 and M24 may be different to implement rendering of different logic. For example, M23 employs a vertex/pixel shader for rendering particles whose geometry is triangular, and M24 employs a vertex/pixel shader for rendering particles whose geometry is mesh-shaped.

For G3, it includes four effect processing units M31, M32, M33 and M34, wherein M31 may be used to generate a set of particles L3, M32 and M33 may be used to update the attributes of L3, and M34 may be used to render the updated L3. That is, M31, M32 and M33 are computational shaders and M34 is a vertex/pixel shader. The computational shaders employed by M32 and M33 may be different to implement update of different logic. For example, M32 employs a computational shader for moving particles rightward at an interval of T1, and M33 employs a computational shader for moving particles upward a preset distance at an interval of T2.

To sum up, any two effect processors may or may not be associated with each other. Any two effect processing units in each effect processor may be used to perform the same type of processing, with different processing logic, or may also be used to perform different types of processing, with an association relationship between different types of processing.

S103: according to an association relationship between the effect processing units included in the effect processor, sequentially invoking the effect processing units to process particles corresponding to the effect processor, to obtain an effect picture, wherein each effect processing unit is used for performing one of the following types of processing: generating the particles, updating attributes of the particles, and rendering the particles according to the attributes of the particles, and wherein the particles are display objects of geometry.

The display object is displayed on one or more pixel points, the pixel points constitute the geometry, and the positions, colors, brightness etc. of the pixel points may change over time.

Specifically, when an effect processing unit is invoked, an effect processing unit which is relied on is invoked preferentially, and then effect processing units which depend on remaining effect processing units are invoked. As shown in FIG. 3, for the effect processor G1, the particles are processed mainly by the effect processing unit M11, the effect processing unit M12 and the effect processing unit M13 successively. For the effect processor G2, the particles are processed mainly by the effect processing units M21, M22, M23 and M24 successively. For the effect processor G3, the particles are processed mainly by the effect processing units M31, M32, M33 and M34 successively.

With reference to FIG. 4, when the effect processing units in the above-mentioned effect processor comprises: a particle generating unit, a particle updating unit and a particle rendering unit, S103 may include: firstly, invoking the particle generating unit to generate particles; then invoking the particle updating unit to update the attributes of the particles; finally, invoking the particle rendering unit to render the particles according to the attributes of the particles.

The particle generating unit needs not only to generate particles, but also to initialize the attributes of the particles. The particle generating unit uses the computational shader.

upon generating the particles, it is necessary to initialize the attributes of the particles, and the attributes of the particle are stored in a separate memory. The attributes of the particles include, but are not limited to: a position, a color, a movement direction, a movement speed, a current display duration, a maximum display duration and a size. The current display duration refers to a duration in which the particles already exist, and the maximum display duration is used to limit a display duration of the particles. When the current display duration of the particles reaches the maximum display duration, the particles are no longer displayed.

When the particles are initialized, the position, color, movement direction, movement speed, maximum display duration and size of the particles may all be set according to actual needs, and the current display duration needs to be set as 0. The initial attributes of the particles may also be specified in the effect resource data.

The particle updating unit is used for updating the attributes of the particles according to a certain logic. The logic may be determined by a corresponding computational shader. The logic for updating the particles using different computational shaders is different. For example, the particles may be moved rightward at an interval of T1, or the colors of the particles may be modified at the interval of T1, or the movement directions of the particles may be modified at the interval of T1. The particle updating unit uses the computational shader.

It needs to be appreciated that each time a particle is updated, the particle rendering unit needs to be invoked to render the particle. In this way, a visual particle movement is achieved. The particle rendering unit uses the vertex/pixel shader.

Optionally, the particle may be geometry constituted by at least one pixel. Thus, the vertex/pixel shader, when rendering the particle, may render the particle according to the geometry. The geometry may include, but not limited to: points, lines, faces, cubes, wherein the faces may be squares, triangles, strips, meshes, etc. The embodiments of the present disclosure do not limit the geometry of the particles.

It needs to be appreciated that a large number of the above-mentioned particles are constantly updated after being generated, and are rendered once every update. In this way, the movement of the particles is achieved, and forms the effect picture.

Optionally, in order to ensure the computing performance and rendering performance of the particles as much as possible while saving the GPU thread, the embodiment of the present disclosure may start the thread according to the number of particles before proceeding to S103. Specifically, firstly, for each effect processor, the number of threads corresponding to the effect processor is determined according to the number of particles corresponding to the effect processor; threads are then started according to the number of threads, and each thread is used for executing the processing of a particle corresponding to the effect processor.

When the number of threads is the same as the number of particles, GPU threads may not be wasted on the premise of ensuring the computing performance and rendering performance of the particles.

When threads are started, they are usually started in thread groups, i.e., a first number of thread groups are started each time, each thread group comprising a second number of threads, whereby the number of threads started at a time is a product of the first number and the second number. That is, the number of threads corresponding to the effect processor is a multiple of the number of threads included in a thread group. When the thread group comprises 64 threads, if the number of particles is 50000, 782 thread groups will be started, i.e., 782*64=50048 threads. The number of threads 50048 is greater than 50000 and close to 50000.

It can be seen from the depictions of the above S102 that different effect processors may or may not be associated with each other.

When any two effect processors are associated with each other, the attributes of the particles updated by one of the effect processors may be used as input to the next effect processor. A processing procedure upon association between two effect processors is described in detail below.

Specifically, when the at least one effect processor comprises a first effect processor and a second effect processor which are associated with each other and respectively used to process at least one group of first particles and at least one group of second particles which are associated with each other, the effect picture comprises a first sub-picture and a second sub-picture. Thus, S103, when performed, may specifically include:

Firstly, according to an association relationship between effect processing units included in the first effect processor, sequentially invoking the effect processing units to process the first particles to obtain the first sub-picture; then, taking particle identifiers of the first particles as an input to the second effect processor, and according to an association relationship between effect processing units included in the second effect processor, sequentially invoking the effect processing units to process the second particles to obtain the second sub-picture.

Specifically, when the effect processing units are sequentially invoked to process the particles according to an association relationship between effect processing units included in one effect processor, the particles are first processed by the effect processing units which are relied on, and then the particles are processed by effect processing units which depend on remaining effect processing units.

In an embodiment of the present disclosure, the first particles corresponding to the first effect processor and the second particles corresponding to the second effect processor have an association relationship. Thus, it is necessary to input the particle identifiers of the first particles into the second effect processor after the first effect processor processes the first particles so that the effect processor processes the second particles according to the first particles.

Here, the particle identifier is used to uniquely represent a particle, and is an identity of the particle. For example, if there are 10 particles, the particle identifiers for the 10 particles may be an integer in a range of 0 to 9. In this way, the second effect processor may uniquely determine the first particles according to the input particle identifiers so as to process the second particles according to the first particles.

It needs to be appreciated that the processing logic of the second effect processor based on the particle identifiers of the first particles is determined by an effect processing unit in the second effect processor. For example, the second effect processor may determine whether the first particles disappear upon receiving the input particle identifiers of the first particles, and if the first particles disappear, generate the second particles at positions where the first particles disappear. For another example, the second effect processor may determine whether a state of the first particles reaches a target state upon receiving the input particle identifiers of the first particles, and generate the second particles if the target state is reached; as a further example, the second effect processor may update the attributes of the second particles upon receiving that the state of the input first particles reaches the target state, the updating including updating the size, color, position, movement speed, movement direction etc. of the particles. In this way, the diversity of effect pictures may be further improved by associating the first effect processors with the second effect processor which are different so that the particles in the generated effect picture are associated with one another to form a more complex effect.

The above-mentioned first effect processor and second effect processor may be any effect processors shown in FIG. 3, and the effect processing units in each effect processor may each comprise a particle processing unit and a particle rendering unit. Accordingly, taking particle identifiers of the first particles as an input to the second effect processor, and according to an association relationship between effect processing units included in the second effect processor, sequentially invoking the effect processing units to process the second particles to obtain the second sub-picture may comprise:

Firstly, taking the particle identifiers of the first particles as an input to the particle processing units, and invoking the particle processing units to process the second particles, the particle processing units being used for performing one of the following processes: generating the second particles and updating the attributes of the second particles; and invoking the particle rendering unit to render the second particles according to the attributes of the particles to obtain the second sub-picture. As such, the generation or update of the second particles may be controlled according to the first particles so that the effect picture includes two types of associated particles, which helps to further improve the diversity of the effect picture.

It may be understood that when the processing logics of the particle processing units in the second effect processor are different, the processing of the second particles according to the particle identifiers of the first particles is different, and the generated effect pictures are also different.

It needs to be appreciated when the particle processing unit is used to generate the second particles, the particle processing unit may include a particle generating unit. When the particle processing unit is adapted to update the attributes of the second particles, the particle processing unit may comprise a particle updating unit. Certainly, the particle processing unit may further comprise both the particle generating unit and the particle updating unit for generating the second particles and updating the attributes of the second particles.

The shader used by the particle processing unit is a computational shader, and the shader used by the particle rendering unit is a rendering shader.

When there is no association between two effect processors, each effect processor may process the particles separately, and the particles between the two effect processors are not associated.

Optionally, the effect resource data further comprises shader information corresponding to the effect processing units; accordingly, according to an association relationship between the effect processing units included in the effect processor, sequentially invoking the effect processing units to process particles corresponding to the effect processor to obtain an effect picture may comprise: firstly, upon invoking an effect processing unit according to the association relationship between the effect processing units included in the effect processor, uploading a corresponding shader according to shader information; then, invoking the shader to process the particles to obtain the effect picture.

As can be seen from the above process, the shader may be specified in the effect resource data, thus enabling dynamic distribution of the shaders. Therefore, different particle processing logics may be implemented by updating the shader information, thereby achieving the generation logic of dynamically modifying the effect picture, and helping to further improve the diversity of the effect picture.

It needs to be appreciated that the effect processing unit may be any effect processing unit. When the effect processing unit is the particle generating unit, or the particle updating unit, or the particle rendering unit, the embodiments of the present disclosure may thus implement dynamic modification of the generation logic of particles, or dynamic modification of the update logic of the particles, or dynamic modification of the rendering logic of the particles. For example, the generation logic before the modification is to generate particles with a uniform distance and the same color, and the generation logic after the modification is to generate particles with a uniform distance but different colors. As another example, the update logic before the modification may be to modify the movement direction of the particles at the interval of T1, and the update logic after the modification may be to modify the colors of the particles at an interval of R2. As a further example, the rendering logic before the modification may be to render the particles as triangles and the rendering logic after the modification may be to render the particles as meshes.

Optionally, the effect processor may also generate an effect picture according to externally-input data. Specifically, before the step of, according to an association relationship between the effect processing units included in an effect processor, sequentially invoking the effect processing units to process particles corresponding to the effect processor to obtain the effect picture, the method further comprises: receiving externally-input data sent by the CPU, the externally-input data comprising at least one type of the following types: data extracted by the CPU from the user input instruction, and data obtained after converting the extracted data.

Accordingly, the step of, according to an association relationship between the effect processing units included in the effect processor, sequentially invoking the effect processing units to process particles corresponding to the effect processor, comprises:

Taking the externally-input data as an input to the effect processor, and according to the association relationship between effect processing units included in the effect processor, sequentially invoking the effect processing units to process particles corresponding to the effect processor to obtain an effect picture.

Embodiments of the present disclosure may enable user's intervention on the effect picture through the externally-input data. Different user input instructions correspond to different externally-input data, thereby achieving different interventions on the effect picture. As such, different effect pictures may be generated according to different user input instructions, which helps to further improve the diversity of effect pictures.

The processing logic of the effect processor for different externally-input data is determined by the effect processing units in the effect processor. For example, the effect processor may modify the colors of the particle when the externally-input data comprises the user's click operation at location LOC1. As another example, the effect processor may generate new particles when the externally-input data includes the user's double-click operation at location LOC2. As a further example, the effect processor may modify the movement speed of the particles when the externally-input data includes the user's drag operation.

When the effect processing unit in the above-mentioned effect processor comprises the particle processing unit and the particle rendering unit, the above step of taking the externally-input data as an input to the effect processor, and according to the association relationship between effect processing units included in the effect processor, sequentially invoking the effect processing units to process particles corresponding to the effect processor to obtain an effect picture comprises: firstly, taking the externally-input data as an input to the particle processing units, and invoking the particle processing units to process the particles, the particle processing unit being used for performing one type of the following type of processing: generating the particles, and updating attributes of the particles; then invoking the particle rendering unit to render the particles according to the attributes of the particles to obtain the effect picture. In this way, the generation or update of the particles may be controlled according to the externally-input data, so that the particles in the effect picture may be flexibly modified from the external, which helps to further improve the diversity of the effect picture.

It may be understood that when the processing logics of the particle processing units in the effect processor are different, the processing of the particles according to the externally-input data is different, and the generated effect pictures are also different.

It needs to be appreciated that when the particle processing unit is used to generate particles, the particle processing unit may include a particle generating unit. When the particle processing unit is used to update the attributes of the particles, the particle processing unit may comprise a particle updating unit. Certainly, the particle processing unit may further comprise both the particle generating unit and the particle updating unit for generating the particles and updating the attributes of the particles.

Wherein the shader used by the particle processing unit is a computational shader, and the shader used by the particle rendering unit is a rendering shader.

To sum up, different information in the effect resource data may be input to different effect processing units in the effect processor. FIG. 4 exemplarily shows the particle generating unit, the particle updating unit, and the particle rendering unit. That is to say, the particles are firstly generated, then the attributes of the particles are updated, and finally the particles are rendered to obtain the effect picture.

Optionally, the effect logic described above may serve as an input to each effect processing unit, so that the effect processing unit processes the particles after completion of the processing of an effect processing unit that is replied on by the effect processing unit.

Optionally, the above-mentioned externally-input data may serve as an input to the particle generating unit, so that the particle generating unit generates particles according to the externally-input data, different externally-input data corresponding to different particle generation logics.

Optionally, the above-mentioned externally-input data may also serve as an input to the particle updating unit, so that the particle updating unit updates the particles according to the externally-input data, different externally-input data corresponding to different particle update logics.

Optionally, the initialized attributes of the particles may serve as input to the particle generating unit to initialize the attributes of the particles when the particle generating unit generates the particles.

Optionally, an internal attribute is time, and may be respectively input to the particle generating unit, the particle updating unit and the particle rendering unit, so that the three effect processing units perform processing according to the time.

Optionally, internal textures may serve as an input to the particle rendering unit so that the particle rendering unit performs particle rendering according to the internal textures.

Optionally, the shader information of the effect processing unit may serve as an input to the effect processing unit, so that the effect processing unit invokes the shader corresponding to the shader information to process the particles.

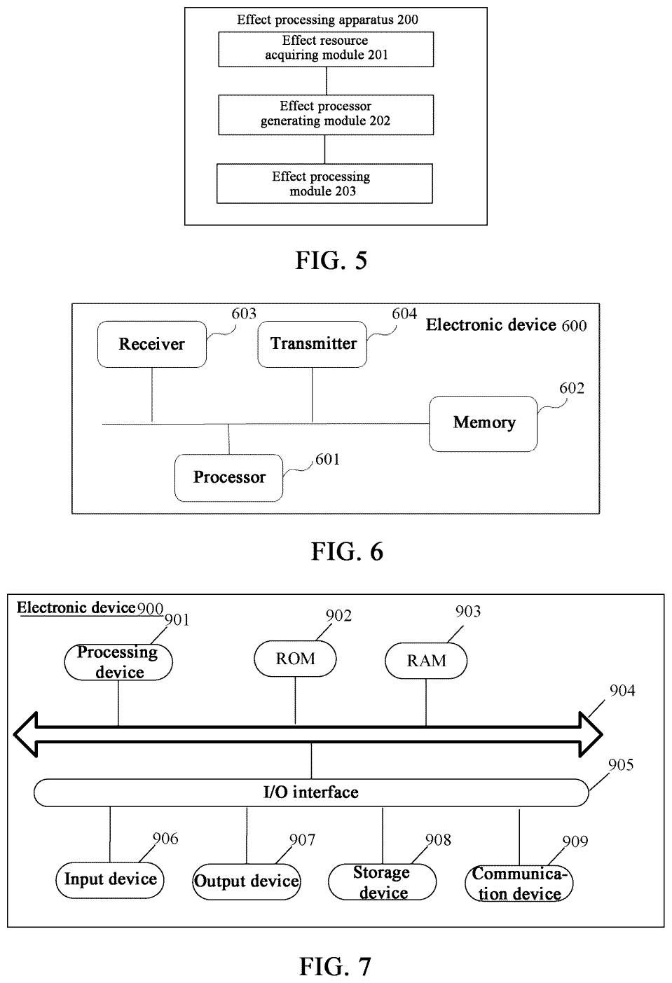

Corresponding to the specific processing method of the above embodiments in the preceding text, FIG. 5 is a block diagram of a specific processing apparatus provided by an embodiment of the present disclosure. For ease of description, FIG. 5 only shows portions related to the present embodiment of the present disclosure. With reference to FIG. 5, the above-mentioned effect processing apparatus 200 comprises: an effect resource acquiring module 201, an effect processor generating module 202 and an effect processing module 203.

The effect resource acquiring module 201 is used to acquire effect resource data comprising a self-defined effect logic, the effect logic being used for specifying at least one effect processor and at least two associated effect processing units included in each effect processor.

The effect processor generating module 202 is used to generate the effect processor and the effect processing units according to the effect logic, each effect processor corresponding to a set of particles, and the effect processing units being used for processing the particles through a shader of a Graphic Processing Unit GPU.

The effect processing module 203 is used to, according to an association relationship between the effect processing units included in the effect processor, sequentially invoke the effect processing units to process particles corresponding to the effect processor, to obtain an effect picture, wherein each effect processing unit is used for performing one type of the following type of processing: generating the particles, updating attributes of the particles, and rendering the particles according to the attributes of the particles, and wherein the particles are display objects of geometry.

Optionally, the at least one effect processor comprises a first effect processor and a second effect processor which are associated with each other and respectively used to process at least one group of first particles and at least one group of second particles which are associated with each other, the effect picture comprises a first sub-picture and a second sub-picture, and the effect processing module 203 is further used to:
according to an association relationship between effect processing units included in the first effect processor, sequentially invoke the effect processing units to process the first particles to obtain the first sub-picture; take particle identifiers of the first particles as an input to the second effect processor, and according to the association relationship between effect processing units included in the second effect processor, sequentially invoke the effect processing units to process the second particles to obtain the second sub-picture.

Optionally, the effect processing units in the effect processor comprises a particle processing unit and a particle rendering unit, and the effect processing module 203 is further used to:
take the particle identifiers of the first particles as an input to the second effect processor, and according to the association relationship between effect processing units included in the second effect processor, sequentially invoke the effect processing units to process the second particles to obtain the second sub-picture; take particle identifiers of the first particles as an input to the particle processing unit, and invoke the particle processing unit to process the second particles, wherein the particle processing unit is used for performing one of the following types of processing: generating the second particles, and updating attributes of the second particles, invoke the particle rendering unit to render the second particles according to the attributes of the particles to obtain the second sub-picture.

Optionally, the effect resource data further comprises shader information corresponding to the effect processing unit; the effect processing module 203 is further used to:

Upon invoking an effect processing unit according to the association relationship between the effect processing units included in the effect processor, upload a corresponding shader according to the shader information; invoke the shader to process the particles to obtain the effect picture.

Optionally, the apparatus further comprises an externally-input data receiving module:
the externally-input data receiving module is used to, before sequentially invoking the effect processing units to process particles corresponding to the effect processor to obtain the effect picture, according to the association relationship between the effect processing units included in the effect processor, receive externally-input data sent by the CPU, the externally-input data comprising at least one of: data extracted by the CPU from a user input instruction, and data obtained after converting the extracted data.

Based on the externally-input data receiving module, the effect processing module 203 is further used to:
take the externally-input data as an input to the effect processor, and according to the association relationship between effect processing units included in the effect processor, sequentially invoke the effect processing units to process particles corresponding to the effect processor to obtain the effect picture.

Optionally, the effect processing unit in the effect processor comprises: a particle processing unit and a particle rendering unit, and the effect processing module 203 is further used to:
upon taking the externally-input data as an input to the effect processor, and according to the association relationship between effect processing units included in the effect processor, sequentially invoking the effect processing units to process particles corresponding to the effect processor to obtain the effect picture, take the externally-input data as an input to the particle processing units, and invoke the particle processing units to process the particles, the particle processing unit being used for performing one type of the following type of processing: generating the particles and updating attributes of the particles; invoke the particle rendering unit to render the particles according to the attributes of the particles to obtain the effect picture.

Optionally, the effect processing unit in the effect processor comprises: a particle generating unit, a particle updating unit and a particle rendering unit, and the effect processing module 203 is further used to:
invoke the particle generating unit to generate the particles; invoke the particle updating unit to update attributes of the particles; invoke the particle rendering unit to render the particles according to the attributes of the particles.

Optionally, the apparatus further comprises a thread number determining module and a thread starting module:
the thread number determining module is used to determine a number of threads corresponding to the effect processor according to a number of particles corresponding to the effect processor, before sequentially invoking the effect processing units to process the particles corresponding to the effect processor to obtain the effect picture, according to the association relationship between the effect processing units included in the effect processor.

The thread starting module is used to start threads according to the number of threads, each of the threads being used for executing the processing of a particle corresponding to the effect processor.

Optionally, the number of threads is a multiple of the number of threads included by a thread group.

Optionally, the particle is a geometry constituted by at least one pixel point.

The effect processing apparatus provided in the present embodiment may be used to execute the technical solution of the above method embodiment shown in FIG. 2. The implementation principles and technical effects of the effect processing apparatus are similar to those of the method embodiment and will not be detailed in the present embodiment.

FIG. 6 is a block diagram of an electronic device 600 provided by an embodiment of the present disclosure. The electronic device 600 comprises a memory 602 and at least one processor 601.

The memory 602 stores computer-executed instructions therein.

The at least one processor 601 executes computer-implemented instructions stored in the memory 602 to cause the electronic device 601 to implement the effect processing method of FIG. 2.

Furthermore, the electronic device may further comprise a receiver 603 and a transmitter 604, wherein the receiver 603 is used for receiving information from remaining devices or apparatuses and forwarding the information to the processor 601, and the transmitter 604 is used for transmitting the information to the remaining devices or apparatuses.

Furthermore, FIG. 7 is a schematic structural diagram of an electronic device 900 according to an embodiment of the present disclosure. The electronic device 900 may be a terminal device. The terminal device may comprise, but not limited to, mobile terminals such as mobile phones, notebook computers, digital broadcast receivers, PDAs (Personal Digital Assistants), PADs (Tablet Computers), PMPs (Portable Multimedia Players), in-vehicle terminals (e.g., in-vehicle navigation terminals), etc. and fixed terminals such as digital TVs, desktop computers, etc. The electronic device shown in FIG. 7 is merely an example and should not impose any limitations on the functionality and scope of use of embodiments of the present disclosure.

As shown in FIG. 7, the electronic device 900 may comprise a processing device (e.g., a central processing unit, a graph processor, etc.) 901 that may perform various suitable actions and processes in accordance with a program stored in a read only memory (ROM) 902 or a program loaded from a storage device 908 into a random access memory (RAM) 903. In the RAM 903, various programs and data needed by the operation of the electronic device 900 are also stored. The processing device 901, the ROM 902, and the RAM 903 are connected to each other via a bus 904. An input/output (I/O) interface 905 is also coupled to bus 904.

In general, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a liquid crystal display (LCD), a speaker, a vibrator, etc.; a storage device 908 including, for example, a magnetic tape, a hard disk, etc.; and a communication device 909. The communication device 909 may allow the electronic device 900 to communicate in a wireless or wired manner with other devices to exchange data. Although FIG. 7 illustrates the electronic device 900 having various devices, it is to be understood that not all illustrated devices are required to be implemented or provided. More or fewer devices may optionally be implemented or provided.

In particular, the processes described above with reference to flow charts may be implemented as computer software programs in accordance with embodiments of the present disclosure. For example, embodiments of the present disclosure comprise a computer program product comprising a computer program carried on a computer-readable medium, the computer program comprising program code for performing the method illustrated by the flow charts. In such embodiments, the computer program may be downloaded and installed from a network via the communication device 909, or installed from the storage device 908, or installed from the ROM 902. When the computer program is executed by the processing device 901, the above-described functions defined in the method of the embodiments of the present disclosure are performed.

It is appreciated that the computer-readable medium described above in the present disclosure may be either a computer-readable signal medium or a computer-readable storage medium, or any combination of the two. The computer-readable storage medium may be, for example but not limited to, an electronic, magnetic, optical, electromagnetic, infrared, or semiconductor system, apparatus, or device, or a combination of any of the above. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. In the present disclosure, the computer-readable signal medium may comprise a data signal embodied in baseband or propagated as part of a carrier carrying computer-readable program code. Such propagated data signals may take many forms, including but not limited to, electromagnetic signals, optical signals, or any suitable combinations thereof. The computer-readable signal medium may also be any computer-readable medium other than a computer-readable storage medium that may send, propagate, or transport the program for use by or for use in conjunction with the instruction execution system, apparatus, or device. The program code contained on the computer-readable medium may be transmitted with any suitable medium including, but not limited to: electrical wire, optic cable, RF (radio frequency), and the like, or any suitable combinations thereof.

The computer readable medium may be contained in the above-described electronic device; it may also be present separately and not installed into the electronic device.

The computer readable medium carries one or more programs which, when executed by the electronic device, cause the electronic device to perform the method shown in the above embodiments.

The computer program code for carrying out operations of the present disclosure may be written in one or more programming languages or combinations thereof. The programming languages include, but not limited to, object-oriented programming languages, such as Java, smalltalk, C++, and conventional procedural programming languages, such as the “C” language or similar programming languages. The program code may be executed entirely on the user's computer, executed partly on the user's computer, executed as a stand-alone software package, executed partly on the user's computer and partly on a remote computer, or executed entirely on the remote computer or a server. In the case of the remote computer, the remote computer may be connected to the user's computer through any type of network, including a local area network (LAN) or a wide area network (WAN), or it may be connected to an external computer (e.g., through the Internet using an Internet Service Provider).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special-purpose hardware and computer instructions.

The units described in connection with the embodiments disclosed herein may be implemented in a software or hardware manner. The names of the units do not constitute limitations of the units themselves in a certain case. For example, the effect processing unit may further be described as “a unit for performing effect processing”.

The functions described herein above may be performed, at least in part, by one or more hardware logic components. For example, without limitation, exemplary types of hardware logic components that may be used comprise: a Field Programmable Gate Array (FPGA), an Application Specific Integrated Circuits (ASIC), an Application Specific Standard Products (ASSP), a Systems On Chip (SOC), a Complex Programmable Logic Device (CPLD), and so on.

In the context of the present disclosure, the machine-readable medium may be a tangible medium that may contain or store a program for use by or for use in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combinations thereof. More specific examples of the machine-readable storage medium would comprise an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination thereof.

In a first example of the first aspect, embodiments of the present disclosure provide an effect processing method, comprising:
acquiring effect resource data comprising a self-defined effect logic, the effect logic being used for specifying at least one effect processor and at least two associated effect processing units included in each effect processor;
generating the effect processor and the effect processing units according to the effect logic, each effect processor corresponding to a set of particles, and the effect processing units being used for processing the particles through a shader of a Graphic Processing Unit GPU;
according to an association relationship between the effect processing units included in the effect processor, sequentially invoking the effect processing units to process particles corresponding to the effect processor, to obtain an effect picture, wherein each of the effect processing units is used for performing one type of the following type of processing: generating the particles, updating attributes of the particles, and rendering the particles according to the attributes of the particles, and wherein the particles are display objects of geometry.

Based on the first example of the first aspect, in a second example of the first aspect, the at least one effect processor includes a first effect processor and a second effect processor which are associated with each other and respectively used to process at least one group of first particles and at least one group of second particles which are associated with each other; the effect picture comprises a first sub-picture and a second sub-picture, and according to an association relationship between effect processing units included in the first effect processor, sequentially invoking the effect processing units to process the particles corresponding to the effect processor to obtain the effect picture comprises:
according to an association relationship between the effect processing units included in the first effect processor, sequentially invoking the effect processing units to process the first particles to obtain the first sub-picture;
taking particle identifiers of the first particles as an input to the second effect processor, and according to the association relationship between effect processing units included in the second effect processor, sequentially invoking the effect processing units to process the second particles to obtain the second sub-picture.

Based on the second example of the first aspect, in a third example of the first aspect, the effect processing units in the effect processor comprise a particle processing unit and a particle rendering unit; the taking particle identifiers of the first particles as an input to the second effect processor, and according to the association relationship between effect processing units included in the second effect processor, sequentially invoking the effect processing units to process the second particles to obtain the second sub-picture comprises:
taking particle identifiers of the first particles as an input to the particle processing unit, and invoking the particle processing unit to process the second particles, wherein the particle processing unit is used for performing one of the following type of processing: generating the second particles, and updating attributes of the second particles;
invoking the particle rendering unit to render the second particles according to the attributes of the particles to obtain the second sub-picture.

Based on the first example of the first aspect, in a fourth example of the first aspect, the effect resource data further comprises shader information corresponding to the effect processing unit, and according to an association relationship between the effect processing units included in the effect processor, sequentially invoking the effect processing units to process particles corresponding to the effect processor, to obtain an effect picture comprises:
upon invoking an effect processing unit according to the association relationship between the effect processing units included in the effect processor, uploading a corresponding shader according to the shader information;
invoking the shader to process the particles to obtain the effect picture.

Based on the first example of the first aspect, in a fifth example of the first aspect, before according to an association relationship between the effect processing units included in the effect processor, sequentially invoking the effect processing units to process particles corresponding to the effect processor, to obtain an effect picture, further comprises:
receiving externally-input data sent by a Central Processing Unit (CPU), the externally-input data comprising at least one of: data extracted by the CPU from a user input instruction, and data obtained after converting the extracted data;
according to an association relationship between the effect processing units included in the effect processor, sequentially invoking the effect processing units to process particles corresponding to the effect processor comprises:
taking the externally-input data as an input to the effect processor, and according to the association relationship between the effect processing units included in the effect processor, sequentially invoking the effect processing units to process particles corresponding to the effect processor to obtain the effect picture.

Based on the fifth example of the first aspect, in a sixth example of the first aspect, the effect processing unit in the effect processor comprises: a particle processing unit and a particle rendering unit; the taking the externally-input data as an input to the effect processor, and according to the association relationship between the effect processing units included in the effect processor, sequentially invoking the effect processing units to process particles corresponding to the effect processor to obtain the effect picture comprises:
taking the externally-input data as an input to the particle processing units, and invoking the particle processing units to process the particles, the particle processing unit is used for performing one of the following types of processing: generating the particles and updating attributes of the particles;
invoking the particle rendering unit to render the particles according to the attributes of the particles to obtain the effect picture.

Based on the fifth example of the first aspect, in a seventh example of the first aspect, the effect processing unit in the effect processor comprises: a particle generating unit, a particle updating unit and a particle rendering unit and wherein, according to an association relationship between the effect processing units included in the effect processor, sequentially invoking the effect processing units to process particles corresponding to the effect processor comprises: invoking the particle generating units to generate the particles;
invoking the particle updating unit to update attributes of the particles;
invoking the particle rendering unit to render the particles according to the attributes of the particles.

Based on any of the first to seventh examples of the first aspect, in an eighth example of the first aspect, before according to an association relationship between the effect processing units included in the effect processor, sequentially invoking the effect processing units to process particles corresponding to the effect processor to obtain an effect picture, the method further comprises:
determining a number of threads corresponding to the effect processor according to a number of particles corresponding to the effect processor;
starting threads according to the number of threads, each of the threads being used for executing the processing of a particle corresponding to the effect processor.

Based on the eighth example of the first aspect, in a ninth example of the first aspect, the number of threads is a multiple of the number of threads included by a thread group.

Based on the first example of the first aspect, in a tenth example of the first aspect, the particle is a geometry constituted by at least one pixel point.

In a first example of a second aspect, there is provided an effect processing apparatus, comprising:
an effect resource acquiring module for acquiring effect resource data comprising a self-defined effect logic, the effect logic being used for specifying at least one effect processor and at least two associated effect processing units included in each effect processor;
an effect processor generating module for generating the effect processor and the effect processing units according to the effect logic, each effect processor corresponding to a set of particles, and the effect processing units being used for processing the particles through a shader of a Graphic Processing Unit GPU;
an effect processing module for according to an association relationship between the effect processing units included in the effect processor, sequentially invoke the effect processing units to process particles corresponding to the effect processor, to obtain an effect picture, wherein each effect processing unit is used for performing one type of the following type of processing: generating the particles, updating attributes of the particles, and rendering the particles according to the attributes of the particles, and wherein the particles are display objects of geometry.

Based on the first example of the second aspect, in a second example of the second aspect, the at least one effect processor comprises a first effect processor and a second effect processor which are associated with each other and respectively used to process at least one group of first particles and at least one group of second particles which are associated with each other; the effect picture comprises a first sub-picture and a second sub-picture; the effect processing module is further used to:
according to an association relationship between the effect processing units included in the first effect processor, sequentially invoke the effect processing units to process the first particles to obtain the first sub-picture; take particle identifiers of the first particles as an input to the second effect processor, and according to the association relationship between effect processing units included in the second effect processor, sequentially invoke the effect processing units to process the second particles to obtain the second sub-picture.

Based on the second example of the second aspect, in a third example of the second aspect, the effect processing units in the effect processor comprise a particle processing unit and a particle rendering unit; the effect processing module is further used to:
upon taking particle identifiers of the first particles as an input to the second effect processor, and according to the association relationship between effect processing units included in the second effect processor, sequentially invoking the effect processing units to process the second particles to obtain the second sub-picture, take particle identifiers of the first particles as an input to the particle processing unit, and invoke the particle processing unit to process the second particles, wherein the particle processing unit is used for performing one type of the following type of processing: generating the second particles, and updating attributes of the second particles; invoke the particle rendering unit to render the second particles according to the attributes of the particles to obtain the second sub-picture.

Based on the first example of the second aspect, in a fourth example of the second aspect, the effect resource data further comprises shader information corresponding to the effect processing unit; the effect processing module is further used to:
upon invoking an effect processing unit according to the association relationship between the effect processing units included in the effect processor, upload a corresponding shader according to the shader information; invoke the shader to process the particles to obtain the effect picture.

Based on the first example of the second aspect, in a fifth example of the second aspect, the apparatus further comprises an externally-input data receiving module;
the externally-input data receiving module is used to, before, according to an association relationship between the effect processing units included in the effect processor, sequentially invoke the effect processing units to process particles corresponding to the effect processor, to obtain an effect picture, receive externally-input data sent by a Central Processing Unit (CPU), the externally-input data comprising at least one of: data extracted by the CPU from a user input instruction, and data obtained after converting the extracted data;
based on the externally-input data receiving module, the effect processing module is further sued to:
take the externally-input data as an input to the effect processor, and according to the association relationship between the effect processing units included in the effect processor, sequentially invoke the effect processing units to process particles corresponding to the effect processor to obtain the effect picture.

Based on the fifth example of the second aspect, in a sixth example of the second aspect, the effect processing unit in the effect processor comprises: a particle processing unit and a particle rendering unit, and the effect processing module is further used to:
upon taking the externally-input data as an input to the effect processor, and according to the association relationship between the effect processing units included in the effect processor, sequentially invoking the effect processing units to process particles corresponding to the effect processor to obtain the effect picture, take the externally-input data as an input to the particle processing units, and invoke the particle processing units to process the particles, the particle processing unit being used for performing one type of the following type of processing: generating the particles and updating attributes of the particles; invoke the particle rendering unit to render the particles according to the attributes of the particles to obtain the effect picture.

Based on the first example of the second aspect, in a seventh example of the second aspect, the effect processing unit in the effect processor comprises: a particle generating unit, a particle updating unit and a particle rendering unit, and the effect processing module is used to:
invoke the particle generating units to generate the particles; invoke the particle updating unit to update attributes of the particles; invoke the particle rendering unit to render the particles according to the attributes of the particles.

Based on any of the first to seventh examples of the second aspect, in an eighth example of the second aspect, the apparatus further comprises a thread number determining module and a thread starting module;
the thread number determining module is used to determine a number of threads corresponding to the effect processor according to a number of particles corresponding to the effect processor, before sequentially invoking the effect processing units to process the particles corresponding to the effect processor to obtain the effect picture, according to the association relationship between the effect processing units included in the effect processor;
the thread starting module is used to start threads according to the number of threads, each of the threads being used for executing the processing of a particle corresponding to the effect processor.

Based on the eighth example of the second aspect, in a ninth example of the second aspect, the number of threads is a multiple of the number of threads included by a thread group.

Based on the first example of the second aspect, in a tenth example of the second aspect, the particle is a geometry constituted by at least one pixel point.

In a third aspect, according to one or more embodiments of the present disclosure, there is provided an electronic device comprising: at least one processor and a memory;
the memory stores computer-executable instructions;
the at least one processor executes the computer-executable instructions stored in the memory, to cause the electronic device to implement the method of any of the examples of the first aspect.

In a fourth aspect, according to one or more embodiments of the present disclosure, there is provided a computer-readable storage medium having stored therein computer-executable instructions which, when executed by a processor, cause a computing device to implement the method of any of examples of the first aspect.

In a fifth aspect, according to one or more embodiments of the present disclosure, there is provided a computer program for implementing the method of any of examples of the first aspect.

In a sixth aspect, according to one or more embodiments of the present disclosure, there is provided a computer program product comprising a computer program for implementing the method of any of examples of the first aspect.

What are described above are only preferred embodiments of the present disclosure and illustrate the technical principles employed. It will be appreciated by those skilled in the art that the scope of the present disclosure is not limited to technical solutions formed by specific combinations of the above technical features, and meanwhile should also comprise other technical solutions formed by any combinations of the above technical features or equivalent features thereof, for example, technical solutions formed by replacement of the above technical features with technical features having similar functions disclosed by the present disclosure.

In addition, while operations are depicted in a particular order, this should not be understood as requiring that the operations be performed in the particular order shown or in a sequential order. In certain circumstances, multitasking and parallel processing may be advantageous. As such, while several specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

What is claimed is:

1. A effect processing method, comprising:
acquiring effect resource data comprising a self-defined effect logic, the effect logic being used for specifying at least one effect processor and at least two associated effect processing units included in each effect processor;
generating the effect processor and the effect processing units according to the effect logic, each effect processor corresponding to a set of particles, and the effect processing units being used for processing the particles through a shader of a Graphic Processing Unit GPU;
according to an association relationship between the effect processing units included in the effect processor, sequentially invoking the effect processing units to process particles corresponding to the effect processor, to obtain an effect picture, wherein each of the effect processing units is used for performing one of the following types of processing: generating the particles, updating attributes of the particles, and rendering the particles according to the attributes of the particles, and wherein the particles are display objects of geometry.

2. The method of claim 1, wherein the at least one effect processor includes a first effect processor and a second effect processor which are associated with each other and respectively used to process at least one group of first particles and at least one group of second particles which are associated with each other; the effect picture includes a first sub-picture and a second sub-picture, and according to an association relationship between effect processing units included in the first effect processor, sequentially invoking the effect processing units to process the particles corresponding to the effect processor to obtain the effect picture comprises:
according to an association relationship between the effect processing units included in the first effect processor, sequentially invoking the effect processing units to process the first particles to obtain the first sub-picture;
taking particle identifiers of the first particles as an input to the second effect processor, and according to the association relationship between effect processing units included in the second effect processor, sequentially invoking the effect processing units to process the second particles to obtain the second sub-picture.

3. The method of claim 2, wherein the effect processing units in the effect processor include a particle processing unit and a particle rendering unit; taking particle identifiers of the first particles as an input to the second effect processor, and according to the association relationship between the effect processing units included in the second effect processor, sequentially invoking the effect processing units to process the second particles to obtain the second sub-picture comprises:
taking particle identifiers of the first particles as an input to the particle processing unit, and invoking the particle processing unit to process the second particles, wherein the particle processing unit is used for performing one of the following types of processing: generating the second particles, and updating attributes of the second particles;
invoking the particle rendering unit to render the second particles according to the attributes of the particles to obtain the second sub-picture.

4. The method of claim 1, wherein the effect resource data further comprises shader information corresponding to the effect processing unit, and according to an association relationship between the effect processing units included in the effect processor, sequentially invoking the effect processing units to process particles corresponding to the effect processor, to obtain an effect picture comprises:
upon invoking an effect processing unit according to the association relationship between the effect processing units included in the effect processor, uploading a corresponding shader according to the shader information;
invoking the shader to process the particles to obtain the effect picture.

5. The method of claim 1, wherein before according to an association relationship between the effect processing units included in the effect processor, sequentially invoking the effect processing units to process particles corresponding to the effect processor, to obtain an effect picture, the method further comprises:
receiving externally-input data sent by a Central Processing Unit (CPU), the externally-input data comprising at least one of: data extracted by the CPU from a user input instruction, and data obtained after converting the extracted data; and
wherein according to an association relationship between the effect processing units included in the effect processor, sequentially invoking the effect processing units to process particles corresponding to the effect processor comprises:
taking the externally-input data as an input to the effect processor, and according to the association relationship between the effect processing units included in the effect processor, sequentially invoking the effect processing units to process particles corresponding to the effect processor to obtain the effect picture.

6. The method of claim 5, wherein the effect processing unit in the effect processor comprises: a particle processing unit and a particle rendering unit, and wherein taking the externally-input data as an input to the effect processor, and according to the association relationship between the effect processing units included in the effect processor, sequentially invoking the effect processing units to process particles corresponding to the effect processor to obtain the effect picture comprises:
taking the externally-input data as an input to the particle processing units, and invoking the particle processing units to process the particles, wherein the particle processing unit is used for performing one of: generating the particles, or updating attributes of the particles;
invoking the particle rendering unit to render the particles according to the attributes of the particles to obtain the effect picture.

7. The method of claim 1, wherein the effect processing unit in the effect processor comprises: a particle generating unit, a particle updating unit and a particle rendering unit, and wherein according to an association relationship between the effect processing units included in the effect processor, sequentially invoking the effect processing units to process particles corresponding to the effect processor comprises:
invoking the particle generating units to generate the particles;
invoking the particle updating unit to update attributes of the particles;
invoking the particle rendering unit to render the particles according to the attributes of the particles.

8. The method of claim 1, wherein before according to an association relationship between the effect processing units included in the effect processor, sequentially invoking the effect processing units to process particles corresponding to the effect processor to obtain an effect picture, the method further comprises:
determining a number of threads corresponding to the effect processor according to a number of particles corresponding to the effect processor;
starting threads according to the number of threads, each of the threads being used for executing the processing of a particle corresponding to the effect processor.

9. The method of claim 8, wherein the number of threads is a multiple of the number of threads included by a thread group.

10. (canceled)

11. An electronic device, comprising: at least one processor and a memory;
the memory storing computer-executable instructions;
the at least one processor executing the computer-executable instructions stored in the memory, to cause the electronic device to:
acquire effect resource data comprising a self-defined effect logic, the effect logic being used for specifying at least one effect processor and at least two associated effect processing units included in each effect processor;
generate the effect processor and the effect processing units according to the effect logic, each effect processor corresponding to a set of particles, and the effect processing units being used for processing the particles through a shader of a Graphic Processing Unit GPU;
according to an association relationship between the effect processing units included in the effect processor, sequentially invoke the effect processing units to process particles corresponding to the effect processor, to obtain an effect picture, wherein each of the effect processing units is used for performing one of the following types of processing: generating the particles, updating attributes of the particles, and rendering the particles according to the attributes of the particles, and wherein the particles are display objects of geometry.

12-13. (canceled)

14. A computer program product being stored in a non-transient computer storage medium and comprising machine-executable instructions which, when executed by a device, cause the device to perform acts comprising a computer program for:
acquiring effect resource data comprising a self-defined effect logic, the effect logic being used for specifying at least one effect processor and at least two associated effect processing units included in each effect processor;
generating the effect processor and the effect processing units according to the effect logic, each effect processor corresponding to a set of particles, and the effect processing units being used for processing the particles through a shader of a Graphic Processing Unit GPU;
according to an association relationship between the effect processing units included in the effect processor, sequentially invoking the effect processing units to process particles corresponding to the effect processor, to obtain an effect picture, wherein each of the effect processing units is used for performing one of the following types of processing: generating the particles, updating attributes of the particles, and rendering the particles according to the attributes of the particles, and wherein the particles are display objects of geometry.

15. The electronic device of claim 11, wherein the at least one effect processor includes a first effect processor and a second effect processor which are associated with each other and respectively used to process at least one group of first particles and at least one group of second particles which are associated with each other; the effect picture includes a first sub-picture and a second sub-picture, and according to an association relationship between effect processing units included in the first effect processor, sequentially invoking the effect processing units to process the particles corresponding to the effect processor to obtain the effect picture comprises:
according to an association relationship between the effect processing units included in the first effect processor, sequentially invoking the effect processing units to process the first particles to obtain the first sub-picture;
taking particle identifiers of the first particles as an input to the second effect processor, and according to the association relationship between effect processing units included in the second effect processor, sequentially invoking the effect processing units to process the second particles to obtain the second sub-picture.

16. The electronic device of claim 15, wherein the effect processing units in the effect processor include a particle processing unit and a particle rendering unit; taking particle identifiers of the first particles as an input to the second effect processor, and according to the association relationship between the effect processing units included in the second effect processor, sequentially invoking the effect processing units to process the second particles to obtain the second sub-picture comprises:
taking particle identifiers of the first particles as an input to the particle processing unit, and invoking the particle processing unit to process the second particles, wherein the particle processing unit is used for performing one of the following types of processing: generating the second particles, and updating attributes of the second particles;
invoking the particle rendering unit to render the second particles according to the attributes of the particles to obtain the second sub-picture.

17. The electronic device of claim 11, wherein the effect resource data further comprises shader information corresponding to the effect processing unit, and according to an association relationship between the effect processing units included in the effect processor, sequentially invoking the effect processing units to process particles corresponding to the effect processor, to obtain an effect picture comprises:
upon invoking an effect processing unit according to the association relationship between the effect processing units included in the effect processor, uploading a corresponding shader according to the shader information;
invoking the shader to process the particles to obtain the effect picture.

18. The electronic device of claim 11, wherein the electronic device is configured to, before according to an association relationship between the effect processing units included in the effect processor, sequentially invoke the effect processing units to process particles corresponding to the effect processor, to obtain an effect picture, the electronic device is further configured to:
receive externally-input data sent by a Central Processing Unit (CPU), the externally-input data comprising at least one of: data extracted by the CPU from a user input instruction, and data obtained after converting the extracted data; and
wherein according to an association relationship between the effect processing units included in the effect processor, sequentially invoking the effect processing units to process particles corresponding to the effect processor comprises:
take the externally-input data as an input to the effect processor, and according to the association relationship between the effect processing units included in the effect processor, sequentially invoking the effect processing units to process particles corresponding to the effect processor to obtain the effect picture.

19. The electronic device of claim 18, wherein the effect processing unit in the effect processor comprises: a particle processing unit and a particle rendering unit, and wherein taking the externally-input data as an input to the effect processor, and according to the association relationship between the effect processing units included in the effect processor, sequentially invoking the effect processing units to process particles corresponding to the effect processor to obtain the effect picture comprises:
taking the externally-input data as an input to the particle processing units, and invoking the particle processing units to process the particles, wherein the particle processing unit is used for performing one of: generating the particles, or updating attributes of the particles;
invoking the particle rendering unit to render the particles according to the attributes of the particles to obtain the effect picture.

20. The electronic device of claim 11, wherein the effect processing unit in the effect processor comprises: a particle generating unit, a particle updating unit and a particle rendering unit, and wherein according to an association relationship between the effect processing units included in the effect processor, sequentially invoking the effect processing units to process particles corresponding to the effect processor comprises:
invoking the particle generating units to generate the particles;
invoking the particle updating unit to update attributes of the particles;
invoking the particle rendering unit to render the particles according to the attributes of the particles.

21. The electronic device of claim 11, wherein before according to an association relationship between the effect processing units included in the effect processor, the electronic device is configured to sequentially invoking the effect processing units to process particles corresponding to the effect processor to obtain an effect picture, the electronic device is configured to:
determine a number of threads corresponding to the effect processor according to a number of particles corresponding to the effect processor;
start threads according to the number of threads, each of the threads being used for executing the processing of a particle corresponding to the effect processor.

22. The electronic device of claim 21, wherein the number of threads is a multiple of the number of threads included by a thread group.

23. The computer program product of claim 14, wherein the at least one effect processor includes a first effect processor and a second effect processor which are associated with each other and respectively used to process at least one group of first particles and at least one group of second particles which are associated with each other; the effect picture includes a first sub-picture and a second sub-picture, and according to an association relationship between effect processing units included in the first effect processor, sequentially invoking the effect processing units to process the particles corresponding to the effect processor to obtain the effect picture comprises:
according to an association relationship between the effect processing units included in the first effect processor, sequentially invoking the effect processing units to process the first particles to obtain the first sub-picture;
taking particle identifiers of the first particles as an input to the second effect processor, and according to the association relationship between effect processing units included in the second effect processor, sequentially invoking the effect processing units to process the second particles to obtain the second sub-picture.
